(19) United States
(12) Patent Application Publication
(10) Pub. No.: US 2019/0180263 A1
(43) Pub. Date: Jun. 13, 2019

(54) CARD PROCESSING APPARATUS AND METHOD BY THE SAME

(71) Applicant: TOSHIBA TEC KABUSHIKI KAISHA, Tokyo (JP)

(72) Inventor: Kazuo Shikano, Mishima Shizuoka (JP)

(21) Appl. No.: 16/214,412

(22) Filed: Dec. 10, 2018

(30) Foreign Application Priority Data
Dec. 11, 2017 (JP) 2017-236871

(51) Int. Cl. G06Q 20/20; G06K 7/00; G06K 7/14; G06K 7/10; G06Q 20/40; G06Q 20/06

(52) U.S. Cl. CPC G06Q 20/204; G06K 7/0004; G06K 7/1413; G06Q 20/065; G06K 7/10366; G06Q 20/4014; G06Q 20/209; G06K 7/1417

(57) ABSTRACT

In accordance with an embodiment, a card processing apparatus stores a first identification code if the first identification code relating to member information is acquired based on card data, stores a second identification code if the second identification code relating to electronic money is acquired, processes the member information based on the first identification code, executes a charge processing of the electronic money based on the second identification code if a charge request for the electronic money is received in a state in which the second identification code is stored, and stands by until data of a card having an electronic money function is read if the charge request for the electronic money is received in a state in which the second identification code is not stored.

### CROSS-REFERENCE TO RELATED APPLICATION

This application is based upon and claims the benefit of priority from Japanese Patent Application No. 2017-236871, filed in Dec. 11, 2017, the entire contents of which are incorporated herein by reference.

### FIELD

Embodiments described herein relate generally to a card processing apparatus and a method by the same.

### BACKGROUND

In recent years, a membership card having an electronic money function is widely used. For example, a POS (Point of Sales) terminal, which is a card processing apparatus capable of processing such a card, recognizes a commercial transaction with a member if the membership card is read using a card reader. Then, the POS terminal performs a processing for giving a service point generated in the commercial transaction to the member. If the electronic money is selected as a price payment method for the commercial transaction, a processing for paying a total price relating to the commercial transaction with electronic money associated with the membership card is performed. In such a series of commercial transactions, data of the membership card is read by the card reader only once.

However, if a balance of the electronic money is insufficient and it is necessary to perform charge using the electronic money, since the charge using the electronic money is a processing different from the commercial transaction, it is necessary to read the data of the membership card again. For this reason, handling of the membership card becomes complicated, and the operation becomes troublesome as well.

### DESCRIPTION OF THE DRAWINGS

FIG. 1 is a block diagram illustrating a circuit configuration of main portions of a POS terminal according to an embodiment;

FIG. 2 is a schematic diagram illustrating a main memory area formed in a main memory of the POS terminal;

FIG. 3 is a flowchart depicting procedures of an information processing executed by a processor of the POS terminal executing a control program;

FIG. 4 is a flowchart depicting procedures of an information processing executed by the processor of the POS terminal executing the control program;

FIG. 5 is a flowchart illustrating specific procedures of a charge processing in FIG. 3; and

FIG. 6 is a schematic diagram illustrating a display example of a charge amount input screen.

### DETAILED DESCRIPTION

In accordance with an embodiment, a card processing apparatus comprises a card reader configured to read card data; a first storage module configured to store a first identification code if the first identification code relating to member information is acquired based on the card data; a second storage module configured to store a second identification code if the second identification code relating to electronic money is acquired based on the card data; a first processing module configured to process member information based on the first identification code stored by the first storage module; a second processing module configured to execute a charge processing of the electronic money based on the second identification code if an charge request for electronic money is received in a state in which the second identification code is stored in the second storage module; and a standby module configured to stand by until data of a card having an electronic money function is read if the charge request for the electronic money is received in a state in which the second identification code is not stored in the second storage module.

An embodiment of a card processing apparatus capable of simplifying handling of a membership card having an electronic money function is described below with reference to the accompanying drawings. In the present embodiment, a POS terminal is described as an embodiment of the card processing apparatus.

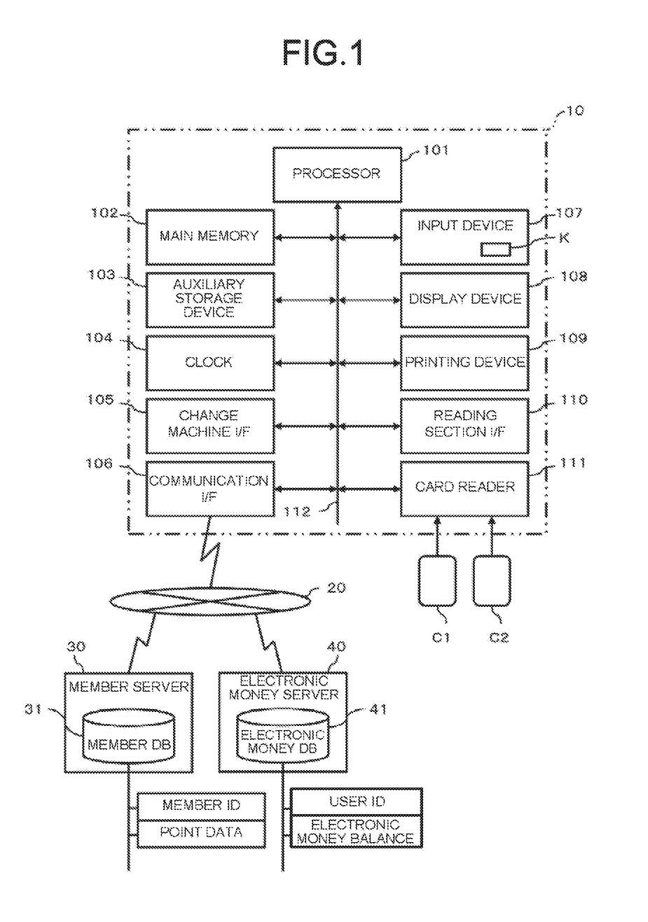

FIG. 1 is a block diagram illustrating a circuit configuration of main portions of a POS terminal 10 according to the present embodiment. The POS terminal 10 includes a processor 101, a main memory 102, an auxiliary storage device 103, a clock 104, a change machine interface 105, a communication interface 106, an input device 107, a display device 108, a printing device 109, a reading section interface 110, a card reader 111 and a system bus 112. Then, in the POS terminal 10, the system bus 112 is electrically connected to the processor 101, the main memory 102, the auxiliary storage device 103, the clock 104, the change machine interface 105, the communication interface 106, the input device 107, the display device 108, the printing device 109, the reading section interface 110 and the card reader 111 directly or via a signal input/output circuit.

In the POS terminal 10, the processor 101, the main memory 102, the auxiliary storage device 103 and the system bus 112 connecting them constitute a computer.

The processor 101 acts as a central part of the computer. The processor 101 controls each section to realize various functions of the POS terminal 10 by executing an operating system and application programs.

The main memory 102 acts as a main memory portion of the computer. The main memory 102 includes a nonvolatile memory area and a volatile memory area. The main memory 102 stores an operating system and an application program in the nonvolatile memory area. The main memory 102 may store data required for the processor 101 to execute a processing for controlling each section in a nonvolatile or volatile memory area in some cases. The main memory 102 uses the volatile memory area as a work area where data is appropriately rewritten by the processor 101.

The auxiliary storage device 103 acts as an auxiliary storage portion of the computer. For example, the auxiliary storage device 103 may be an EEPROM (Electric Erasable Programmable Read-Only Memory), an HDD (Hard Disc Drive), an SSD (Solid State Drive), and the like. The auxiliary storage device 103 stores data used by the processor 101 to perform various processing and data generated in the processing executed by the processor 101. The auxiliary storage device 103 may store the above-described application program in some cases.

The clock 104 functions as a time information source of the POS terminal 10. The processor 101 counts current date and time based on time information measured by the clock 104.

The change machine interface 105 inputs and outputs a data signal from and to an automatic change machine (not shown). For example, the change machine interface 105 inputs deposit amount data from the automatic change machine. The change machine interface 105 outputs change amount data to the automatic change machine. In the automatic change machine, bills or coins corresponding to the change amount according to the change amount data are dispensed.

The communication interface 106 is connected to a network 20 to establish data communication with other devices connected to the network 20 in conformity to a predetermined communication protocol. A member server 30, an electronic money server 40, and the like are connected to the network 20 in addition to a store server for managing a price, sales, inventory, and the like of a commodity sold in a retail store.

The member server 30 manages a member database 31 storing data relating to a member registered as a point member. At least point data is stored in the member database 31 in association with a member ID set for each member to identify the point member.

The electronic money server 40 manages an electronic money database 41 storing data relating to a user registered as an electronic money user. At least electronic money balance is stored in the electronic money database 41 in association with a user ID set for each user to identify the user.

The input device 107 functions as a data input interface to the POS terminal 10. For example, the input device 107 is a keyboard, a touch panel or the like. The input device 107 is provided with a charge key K for declaring charge using the electronic money. The charge key K may be a hardware key arranged on the keyboard or a soft key reproduced on the touch panel.

The display device 108 can display various screens under the control of the processor 101. The display device 108 may be provided with a display device for a store clerk and a display device for a customer separately. For example, the display device 108 may be a liquid crystal display, an EL (Electroluminescence) display, or the like.

The printing device 109 prints a receipt, a voucher, and the like. For example, the printing device 109 may be a thermal printer, an inkjet printer or the like.

The reading section interface 110 inputs and outputs a data signal from and to a reading section (not shown). The reading section is, for example, a scanner for reading a barcode or a two-dimensional data code. If the scanner is connected as the reading section, the reading section interface 110 inputs data included in the barcode or the two-dimensional data code scanned by the scanner. The reading section may be a wireless tag reader/writer. If the wireless tag reader/writer is connected as the reading section, the reading section interface 110 inputs the data included in a wireless tag read by the wireless tag reader/writer. The reading section interface 110 outputs data to be written in the wireless tag to the wireless tag reader/writer.

The card reader 111 reads card data recorded on card media C1 and C2. In the present embodiment, the card medium C1 is a membership card without the electronic money function, and the card medium C2 is a membership card with the electronic money function. The card media C1 and C2 are non-contact type IC cards. The card media C1 and C2 may be contact type IC cards. Alternatively, the card media C1 and C2 may be other cards different from the IC cards. For example, when a portable electronic device such as a smartphone having a near-field wireless communication function stores card data stored in the card medium C1 or the card medium C2, the electronic device is also referred to as a card medium. The card medium C1 and the card medium C2 may be different types of cards. In this case, a plurality of card readers for reading respective types of cards is provided in the POS terminal 10.

In the card medium C1 which is the membership card without the electronic money function, a member ID as the point member is recorded. In the card medium C2 which is the membership card with the electronic money function, the member ID of a point member and a user ID of a user of the electronic money are recorded. Here, the member ID functions as a first identification code relating to the member information. The user ID functions as a second identification code relating to the electronic money.

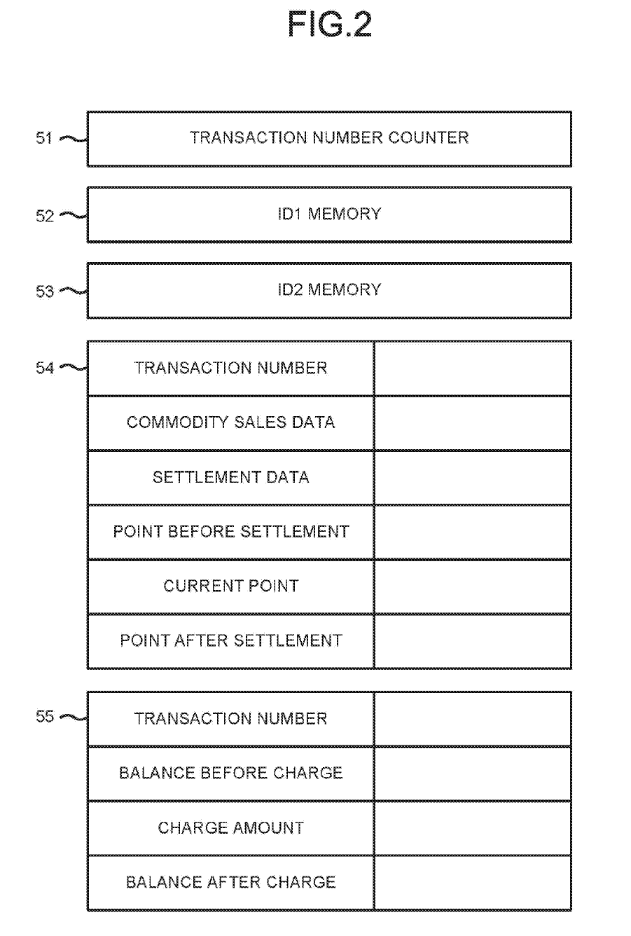

In order to simplify the handling of the membership card with the electronic money function, i.e., the card medium C2, in the POS terminal 10 having such a configuration, memory areas 51 to 55 shown in FIG. 2 are formed in the volatile area in the main memory 102.

In FIG. 2, the memory area 51 is used for counting a series of transaction numbers. Hereinafter, the memory area 51 is referred to as a transaction number counter 51. The memory area 52 is used for storing the first ID read from the card medium C1 or the card medium C2. Hereinafter, the memory area 52 is referred to as an ID1 memory 52. The memory area 53 is used for storing the second ID read from the card medium C1 or the card medium C2. Hereinafter, the memory area 53 is referred to as an ID2 memory 53. The memory area 54 is used for storing data relating to a commercial transaction. The data relating to the commercial transaction includes a transaction number, commodity sales data, settlement data, a point before settlement, a current point, a point after settlement, and the like. Hereinafter, the memory area 54 is referred to as a transaction memory 54. The memory area 55 is used for storing data relating to the charge using the electronic money. The data relating to charge includes a transaction number, a balance before charge, a charge amount, a balance after charge, and the like. Hereinafter, the memory area 55 is referred to as a charge memory 55.

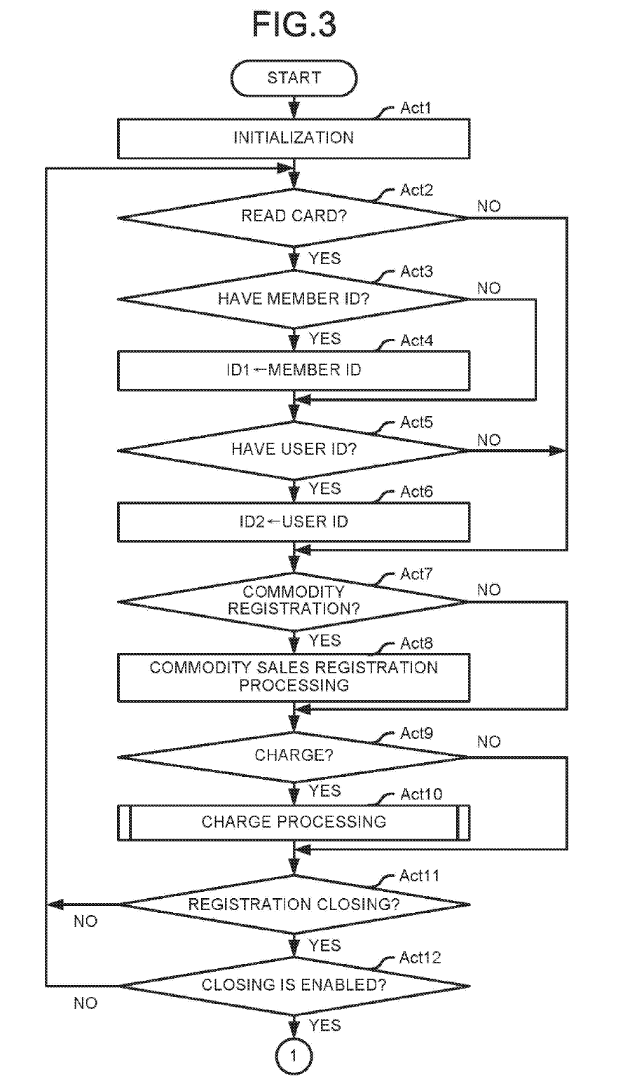

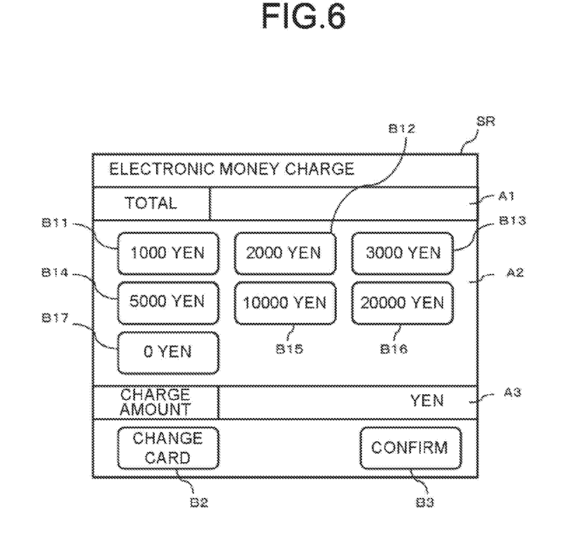

The POS terminal 10 stores a control program for simplifying the handling of the above card medium C2 in the main memory 102 or the auxiliary storage device 103. FIG. 3 to FIG. 5 are flowcharts depicting procedures of the processing executed by the processor 101 executing the control program. FIG. 6 shows an example of a screen displayed on the display device 108 in the processing procedures. The processing procedures of the processor 101 are described below with reference to FIG. 3 to FIG. 6. The procedures described below are merely an example, and the processing of various procedures capable of achieving the same results can be appropriately used.

First, the processor 101 performs an initialization processing in Act 1. The processing includes a processing of clearing the transaction number counter 51, the ID1 memory 52, the ID2 memory 53, the transaction memory 54 and the charge memory 55. If the initialization processing is terminated, the processor 101 proceeds to the processing in Act 2.

In Act 2, the processor 101 determines whether or not the card data is read by the card reader 111. If the card data is not read (No in Act 2), the processor 101 proceeds to the processing in Act 7.

In Act 7, the processor 101 determines whether or not a commodity registration is performed via the input device 107. If the commodity registration is not performed (No in Act 7), the processor 101 proceeds to the processing in Act 9.

In Act 9, the processor 101 determines whether or not the charge key K is operated. If the charge key K is not operated (No in Act 9), the processor 101 proceeds to the processing in Act 11.

In Act 11, the processor 101 determines whether or not or not a closing operation of the commodity registration is performed via the input device 107. If the closing operation is not performed (No in Act 11), the processor 101 returns to the processing in Act 2. Thus, the processor 101 stands by until the card read is read in Act 2, the commodity registration is performed in Act 7, the charge key K is operated in Act 9, or the closing operation of the registration is performed in Act 11.

In the standby state, if it is determined that the card reader 111 reads the card data (Yes in Act 2), the processor 101 determines whether or not the member ID can be acquired from the card data in Act 3. If the member ID can be acquired (Yes in Act 3), the processor 101 stores the member ID in the ID1 memory 52 in Act 4. If the member ID cannot be acquired (No in Act 3), the processor 101 does not execute the processing in Act 4. Here, if the processor 101 acquires the first identification code (member ID) relating to the member information based on the card data by executing the processing in Act 3 and Act 4 through cooperation with the ID1 memory 52, the processor 101 functions as a first storage module for storing the first identification code.

If the processing in Act 4 is terminated or if the member ID cannot be acquired, the processor 101 determines whether or not the user ID can be acquired from the card data in Act 5. If the user ID can be acquired (Yes in Act 5), the processor 101 stores the user ID in the ID2 memory 53 in Act 6. If the user ID cannot be acquired (No in Act 5), the processor 101 does not execute the processing in Act 6. Here, if the processor 101 acquires the second identification code (user ID) relating to the electronic money based on the card data by executing the processing in Act 5 and Act 6 through cooperation with the ID2 memory 53, the processor 101 functions as a second storage module for storing the second identification code.

If the processing in Act 6 is terminated or if the user ID cannot be acquired, the processor 101 proceeds to the processing in Act 7. Specifically, the processor 101 enters the standby state in Act 2, Act 7, Act 9 and Act 11.

Therefore, when a customer who comes for checkout of a purchased commodity presents the card medium C1 or the card medium C2, an operator of the POS terminal 10 uses the card reader 111 to read the data of the card medium C1 or the card medium C2. At this time, if the data of the card medium C1 is read by the card reader 111, the member ID included in the card data is stored in the ID1 memory 52. On the other hand, if the data of the card medium. C2 is read by the card reader 111, the member ID included in the card data is stored in the ID1 memory 52, and the user ID included in the same card data is stored in the ID2 memory 53.

In the standby state in Act 2, Act 7, Act 9 and Act 11, if it is determined that the commodity registration is performed via the input device 107 (Yes in Act 7), the processor 101 executes a commodity sales registration processing.

Specifically, commodity sales data is generated from a price of the registered commodity and is then stored in the transaction memory 54. The processor 101 displays a commodity name, a price, etc. of the registered commodity on the display device 108. Since such commodity sales registration processing is a well-known processing, the detailed description here is omitted.

If the commodity sales registration processing is terminated, the processor 101 proceeds to the processing in Act 9. In other words, the processor 101 enters the standby state in Act 2, Act 7, Act 9 and Act 11.

In the standby state, if it is determined that the charge key K of the input device 107 is operated (Yes in Act 9), the processor 101 executes a charge processing in Act 10. The charge processing is described later. If the charge processing is terminated, the processor 101 proceeds to the processing in Act 11. In other words, the processor 101 enters the standby state in Act 2, Act 7, Act 9 and Act 11.

In this standby state, if it is determined that the closing operation of the commodity registration is performed via the input device 107 (Yes in Act 11), the processor 101 determines whether or not the closing operation of the registration is enabled in Act 12. For example, if no commodity sales data is stored in the transaction memory 54, it is an erroneous operation for performing the closing operation of the registration without performing the commodity registration, and thus, the processor 101 determines that the closing operation of the registration is disenabled. If it is determined that the closing operation of the registration is disenabled (No in Act 12), the processor 101 returns to the processing in Act 2. In other words, the processor 101 enters the standby state in Act 2, Act 7, Act 9 and Act 11.

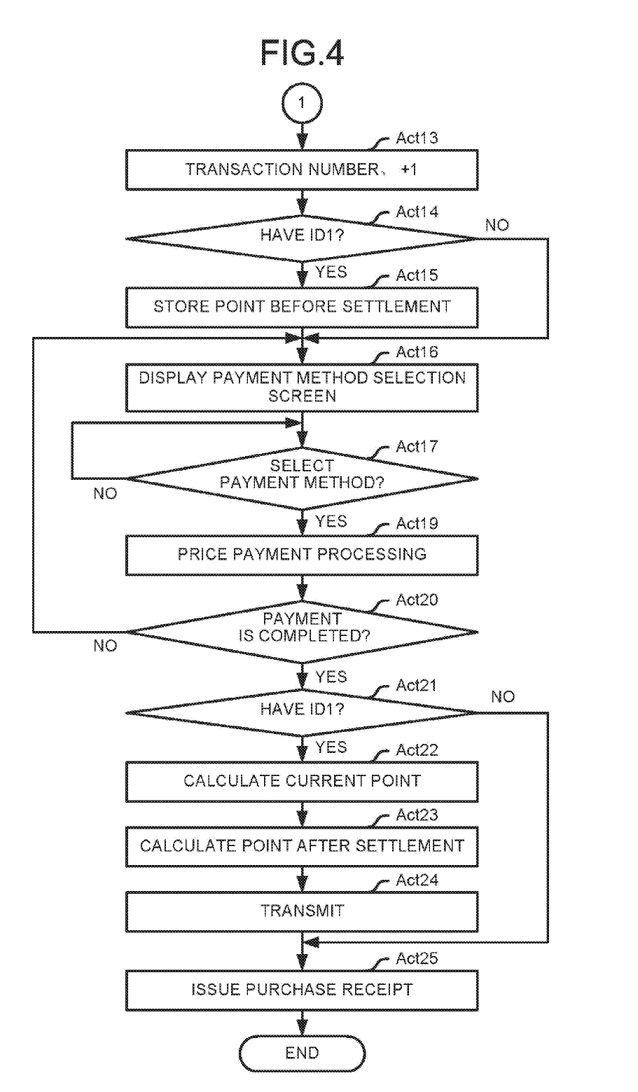

If it is determined that the closing operation of the registration is enabled (Yes in Act 12), the processor 101 proceeds to the processing in Act 13 in FIG. 4. Specifically, the processor 101 counts up a count value in the transaction number counter 51 by “1” in Act 13. Then, the processor 101 stores the count value in the transaction memory 54 as the transaction number.

Next, the processor 101 determines whether or not the member ID is stored in the ID1 memory 52 in Act 14. If the member ID is not stored in the ID1 memory 52 (No in Act 14), the processor 101 proceeds to the processing in Act 16.

If the member ID is stored in the ID1 memory 52 (Yes in Act 14), the processor 101 generates a point request command and controls the communication interface 106 to transmit it to the member server 30 in Act 15. Under this control, the point request command is transmitted from the communication interface 106 to the member server 30 via the network 20. The point request command includes the member ID stored in the ID1 memory 52. In the member server 30 that receives the point request command, the member database 31 is retrieved. Then, the point data associated with the member ID included in the point request command is read out. The point data is transmitted to the POS terminal 10 transmitting the command via the network 20.

Accordingly, the processor 101 which controls transmission of the point request command stands by until the point data is received. If the point data is received via the communication interface 106, the processor 101 stores the point data in the transaction memory 54 as a point before settlement. If the above processing is terminated, the processor 101 proceeds to the processing in Act 16.

In Act 16, the processor 101 controls the display device 108 to display a payment method selection screen. The payment method selection screen is used for selecting a payment method for paying a transaction amount which is the total price of the commercial transaction. The payment methods include, for example, cash payment, credit card payment, electronic money payment, point payment, and the like. The payment method selection screen has a screen structure for receiving selection of any one of the payment methods among these payment methods.

If it is determined that any one of the payment methods is selected via the input device 107 (Yes in Act 17), the processor 101 executes a price payment processing using the selected payment method in Act 19.

For example, if the cash payment is selected, the processor 101 subtracts the transaction amount from the deposit amount input via the input device 107. If there is a change, the processor 101 displays a change amount on the display device 108. The processor 101 stores settlement data such as the transaction amount, the deposit amount, the change amount, etc. in the transaction memory 54. If the deposit amount is not sufficient, the processor 101 displays an insufficient amount thereof on the display device 108.

For example, if the credit card payment is selected, the processor 101 authenticates the credit card read by the card reader 111. Then, if the payment using the credit card is approved, the processor 101 stores the settlement data such as the transaction amount, a card number, a card payment amount, etc. in the transaction memory 54. If the card payment amount is insufficient, the processor 101 displays an insufficient amount thereof on the display device 108.

For example, if the electronic money payment is selected, the processor 101 generates an electronic money request command on condition that the user ID is stored in the ID2 memory 53, and controls the communication interface 106 to transmit it to the electronic money server 40. Under this control, the electronic money request command is transmitted from the communication interface 106 to the electronic money server 40 via the network 20. The electronic money request command includes the user ID stored in the ID2 memory 53. In the electronic money server 40 receiving the electronic money request command, the electronic money database 41 is retrieved. Then, an electronic money balance associated with the user ID included in the electronic money request command is read out. The electronic money balance is transmitted to the POS terminal 10 transmitting the command via the network 20. Therefore, the processor 101 which controls the transmission of the electronic money request command stands by until the electronic money balance is received. If the electronic money balance is received via the communication interface 106, the processor 101 subtracts the transaction amount from the electronic money balance. The processor 101 stores the settlement data such as the transaction amount, the payment amount, etc. in the transaction memory 54. If the electronic money balance is not sufficient, the processor 101 displays an insufficient amount thereof on the display device 108.

For example, if the point payment is selected, the processor 101 generates a point request command on condition that the member ID is stored in the ID1 memory 52, and controls the communication interface 106 to transmit it to the electronic money server 40. Under this control, the point request command is transmitted from the communication interface 106 to the electronic money server 40 via the network 20. The point request command includes the member ID stored in the ID1 memory 52. In the electronic money server 40 receiving the point request command, the same operation as described above is performed. Therefore, the processor 101 which controls the transmission of the point request command stands by until the point data is received. If the point data is received via the communication interface 106, the processor 101 subtracts the total price of the commercial transaction from the point payment amount converted from the point. The processor 101 stores the settlement data such as the transaction amount, the point payment amount, the payment point, etc. in the transaction memory 54. If the point payment amount is not sufficient, the processor 101 displays an insufficient amount thereof on the display device 108.

If the price payment processing is terminated in this way, the processor 101 determines whether or not the payment is completed in Act 20. In the price payment processing, if there is the insufficient amount, the processor 101 determines that the price payment is not completed. If the price payment is not terminated (No in Act 20), the processor 101 returns to the processing in Act 16. In other words, the processor 101 displays the payment method selection screen on the display device 108 again and stands by until a next payment method is selected.

If the price payment is completed (Yes in Act 20), the processor 101 determines whether or not the member ID is stored in the ID1 memory 52 in Act 21. If the member ID is not stored (No in Act 21), the processor 101 proceeds to the processing in Act 25.

If the member ID is stored in the ID1 memory 52 (Yes in Act 21), the processor 21 calculates a current point in Act 22. Specifically, the processor 101 calculates a service point in the current commercial transaction, i.e., the current point, based on commodity sales data or the transaction amount of the settlement data stored in the transaction memory 54. Then, the processor 101 stores the current point in the transaction memory 54. The processor 101 calculates a point after settlement in Act 23. Specifically, the processor 101 adds the current point to the point before settlement stored in the transaction memory 54 to calculate the point after settlement. Then, the processor 101 stores the point after settlement in the transaction memory 54.

Thereafter, the processor 101 generates a point update command, and controls the communication interface 106 to transmit it to the member server 30 in Act 24. Under this control, the point update command is transmitted from the communication interface 106 to the member server 30 via the network 20. The point update command includes the member ID stored in the ID1 memory 52 and the point after settlement stored in the transaction memory 54. In the member server 30 receiving the point update command, the member database 31 is retrieved. Then, point data associated with the member ID included in the point update command is rewritten to the point after settlement included in the same command. If the above processing is terminated, the processor 101 proceeds to the processing in Act 25.

Here, the processor 101 functions as a first processing module which processes member information based on the first identification code (member ID) stored by the first storage module by executing the processing in Act 22 to Act 24.

In Act 25, the processor 101 generates print data of a purchase receipt based on the data stored in the transaction memory 54. Then, the processor 101 outputs the print data to the printing device 109, and controls printing of the purchase receipt. Thus, the processor 101 terminates the information processing according to the control program. Then, the processor 101 executes the processing from Act 1 again.

Therefore, for the customer who presents the card medium C1 or the card medium C2, the current point is calculated in response to execution of the closing operation of the registration of the purchase commodity. Then, the current point is added to the point data associated with the member ID of the customer. The point payment is permitted for the customer who presents the card medium C1 or the card medium C2. The customer can pay for the price of the purchase commodity using the point.

On the other hand, it is possible to handle the electronic money payment without reading the card medium C2 again for the customer who presents the card medium C2. However, it is impossible to handle the electronic money payment unless the customer who presents the card medium C1 presents another card having the electronic money function and the card is read by the card reader 111.

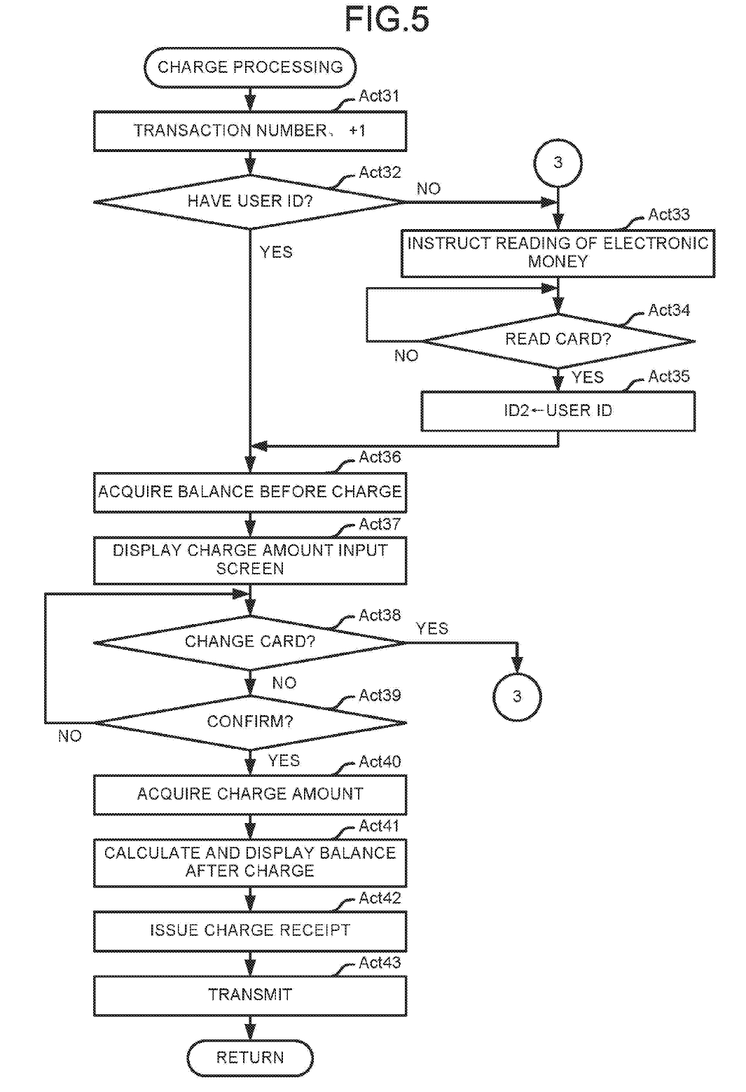

Meanwhile, the customer who presents the card medium C2 can perform charge using the electronic money balance of the card medium C2 before settlement of the commercial transaction. The operator of the POS terminal 10 operates the charge key K if there is a charge request for the electronic money balance from the customer. In response to operation of the charge key K, the processor 101 executes the charge processing in Act 10. Next, the procedures of the charge processing executed by the processor 101 are described with reference to the flowchart in FIG. 5.

If the charge processing is started, the processor 101 counts up a count value of the transaction number counter 51 by “1” in Act 31. Then, the processor 101 stores the count value in the charge memory 55 as a transaction number.

Next, the processor 101 determines whether or not the user ID is stored in the ID2 memory 53 in Act 32. Here, if the user ID is not stored (No in Act 32), the processor 101 displays a screen for instructing reading of a card medium having the electronic money function on the display device 108 in Act 33. Then, the processor 101 stands by until a card medium having the electronic money function is read in Act 34. If the data of the card having the electronic money function is read by the card reader 111 (Yes in Act 34), the processor 101 stores the user ID included in the card data in the ID2 memory 53 in Act 35. Thereafter, the processor 101 proceeds to the processing in Act 36.

Here, the processor 101 functions as a standby module configured to stand by until the data of the card having the electronic money function is read if the charge request for the electronic money is received in a state in which the second identification code (user ID) is not stored by the second storage module by executing the processing in Act 32 to Act 35.

On the other hand, in Act 32, if the user ID is stored in the ID2 memory 53 (Yes in Act 32), the processor 101 skips the processing in Act 33 to Act 35 and proceeds to the processing in Act 36. Specifically, if the charge request for electronic money is received in a state in which the second identification code (user ID) is stored by the second storage module, i.e., if the card medium C2 is read before the charge key K is operated, the processor 101 does not stand by until the data of the card having the electronic money function is read.

In Act 36, the processor 101 acquires a balance before charge from the electronic money server 40. Specifically, the processor 101 generates the electronic money request command and controls the communication interface 106 to transmit it to the electronic money server 40. Under this control, the electronic money request command is transmitted from the communication interface 106 to the electronic money server 40 via the network 20. The electronic money request command includes the user ID stored in the ID2 memory 53. In the electronic money server 40 receiving the electronic money request command, the same operation is performed in the same manner as described above. Therefore, the processor 101 which controls the transmission of the electronic money request command stands by until the electronic money balance is received. If the electronic money balance is received via the communication interface 106, the processor 101 stores the electronic money balance in the charge memory 55 as the balance before charge.

The processor 101 then displays a charge amount input screen SR (refer to FIG. 6) on the display device 108 in Act 37.

FIG. 6 is a schematic diagram illustrating a display example of the charge amount input screen SR. As shown in FIG. 6, the charge amount input screen SR includes a total display area A1, an amount button display area A2 and a charge amount display area A3. The charge amount input screen SR also includes a card change button B2 and a confirmation button B3.

In the amount button display area A2, a 1000 Yen button B11, a 2000 Yen button B12, a 3000 Yen button B13, a 5000 Yen button B14, a 10000 Yen button B15, a 20000 yen button B16 and a 0 Yen button B17 are displayed. The 1000 yen button B11 is used for inputting a charge amount of 1000 Yen. The 2000 yen button B12 is used for inputting a charge amount of 2000 Yen. The same is applicable to the other buttons B13 to B17. However, the 0 Yen button B17 is input when the charge amount is 0 Yen, i.e., when the charge is canceled. It is needless to say that the type of the button displayed in the amount button display area A2 is not limited to that in FIG. 6.

In the total display area A1, the balance before charge stored in the charge memory 55 is displayed. In the charge amount display area A3, the charge amount input through the amount buttons B11 to B17 is displayed.

The operator who confirms the charge amount input screen SR presses the amount buttons B11 to B17 corresponding to the charge amount and then presses the confirmation button B3 if the customer requests the charge using the electronic money. The operator presses the card change button B2 if the customer requests change of the card used for the charge using the electronic money to a card associated with a user ID other than the user ID stored in the ID2 memory 53.

The processor 101 displaying the charge amount input screen SR determines whether or not the card change button B2 is pressed in Act 38. If the card change button B2 is not pressed (No in Act 38), the processor 101 determines whether or not the confirmation button B3 is pressed in Act 39. If the confirmation button B3 is not pressed (No in Act 39), the processor 101 returns to the processing in Act 38. Here, the processor 101 stands by until the card change button B2 is pressed in Act 38 or the confirmation button B3 is pressed in Act 39.

If the card change button B2 is pressed (Yes in Act 38), the processor 101 proceeds to the processing in Act 33. Specifically, the processor 101 displays a screen for instructing reading of a card medium having the electronic money function on the display device 108. If the data of the card having the electronic money function is read through the card reader 111 (Yes in Act 34), the processor 101 stores the user ID included in the card data in the ID2 memory 53 in Act 35. Thereafter, the processor 101 proceeds to the processing in Act 36.

Therefore, the operator who receives a request for changing the card from the customer presses the card change button B2, and then uses the card reader 111 to read the card having the electronic money function that the customer presents. By doing this, the user ID of the card is stored in the ID2 memory 53 and the charge amount input screen SR is displayed again.

On the other hand, if the confirmation button B3 is pressed in the standby state in Act 38 and Act 39 (Yes in Act 39), the processor 101 acquires the charge amount associated with the amount buttons B11 to B17 pressed before the confirmation button B3 is pressed and stores the charge amount in the charge memory 55 in Act 40. The processor 101 calculates the balance after charge by subtracting the charge amount from the balance before charge, and stores it in the charge memory 55. Then, the processor 101 changes a content in the total display area A1 to the balance after charge.

If the processing in Act 41 is terminated, the processor 101 generates print data of a charge receipt based on the contents in the charge memory 55 in Act 42. Then, the processor 101 outputs the print data to the printing device 109 to control the printing of the charge receipt.

The processor 101 generates the electronic money update command, and controls the communication interface 106 to transmit it to the electronic money server 40 in Act 43. Under this control, the electronic money update command is transmitted from the communication interface 106 to the electronic money server 40 via the network 20. The electronic money update command includes the user ID stored in the ID2 memory 53 and the balance after charge stored in the charge memory 55. In the electronic money server 40 receiving the electronic money update command, the electronic money database 41 is retrieved. Then, the electronic money data associated with the user ID included in the electronic money update command is rewritten to the balance after charge included in the same command.

If the above processing is terminated, the processor 101 terminates the charge processing and returns to the processing in Act 11.

Here, the processor 101 functions as a second processing module configured to execute the charge processing of the electronic money based on the second identification code if the charge request for electronic money is received in a state in which the second identification code (user ID) is stored by the second storage module by executing the processing in Act 32 and Act 36 to Act 43.

As described above, according to the present embodiment, after using the card reader 111 to read the data of the card medium C2 as the membership card relating to the commercial transaction, if the customer requests the charge using the electronic money in the card medium C2, the operator can charge the electronic money without reading the data in the card medium C2 again. Therefore, since the reading operation on the card medium C2 is performed only once, the handling of the card medium C2 can be simplified.

In addition, the operator can simply input the corresponding charge amount through the charge amount input screen SR which is displayed after the charge key K is operated, thereby simplifying the operation.

The card change button B2 is displayed in the charge amount input screen SR. if the card change button B2 is operated, a mode for reading the card having the electronic money function is set. Thus, for example, there is an advantage that the operation can be simple even if the customer who presents the card medium C2 as the membership card to accumulate points performs the charge using the electronic money in another card to perform payment using another card having the electronic money function.

In the above embodiment, if the card of which the data is read as the membership card is the card medium C2, the charge amount input screen SR is displayed on the display device 108 when the charge key K is operated. On the other hand, in the case of the card medium C1, when the charge key K is operated, the screen for instructing reading of the card having the electronic money function is displayed on the display device 108. Therefore, the operator can recognize whether the card medium is the card medium C1 that does not have the electronic money function or the card medium C2 that has the electronic money function depending on the difference in the screen displayed after the charge key K is operated. Therefore, the operator does not need to be conscious of whether the card medium is the card medium C1 that does not have the electronic money function or the card medium C2 having the electronic money function, and thus the handling of the card becomes easy from such a point.

Modifications of the present embodiment are described below.

In the above embodiment, the membership card is a card for the point member, but it is not limited to this. For example, it may be a membership card for a stamp member who collects electronic stamps. In this case, the first processing module executes a processing relating to the collection of a stamp as a first processing.

In the above embodiment, the POS terminal is exemplified as an embodiment of the card processing apparatus, but the card processing apparatus is not limited to the POS terminal. Any electronic device may be used as long as it can handle the membership card having the electronic money function.

The access of the card processing apparatus is generally performed in a state in which a program such as a control program is stored in the main memory or the auxiliary storage device. However, it is not limited to this, and for example, the access of the card processing apparatus may be performed in a state in which the program is not stored in the main memory or the auxiliary storage device. In this case, the control program individually transferred from the card processing apparatus is written in a writable storage device of the card processing apparatus according to an operation performed by a user or the like. The transfer of the control program may be performed by recording the control program on a removable recording medium or by communication via a network. The recording medium may be in any form as long as it can store the program and is readable by the apparatus, such as a CD-ROM (Compact Disc Read-Only Memory), a memory card, etc. The function obtained by installing or downloading the program may be realized through cooperation with an OS (operating system) in the apparatus.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A card processing apparatus, comprising:
a card reader configured to read card data;
a first storage module configured to store a first identification code if the first identification code relating to member information is acquired based on the card data;
a second storage module configured to store a second identification code if the second identification code relating to electronic money is acquired based on the card data;
a first processing module configured to process the member information based on the first identification code stored by the first storage module;
a second processing module configured to execute a charge processing of the electronic money based on the second identification code if a charge request for electronic money is received in a first state in which the second identification code is stored in the second storage module; and
a standby module configured to stand by until data of a card having an electronic money function is read if the charge request for electronic money is received in a second state in which the second identification code is not stored in the second storage module.

2. The card processing apparatus according to claim 1, wherein
the second processing module is in a stand by mode until a charge amount is input and executes the charge processing of the electronic money using the input charge amount.

3. The card processing apparatus according to claim 2, wherein
the second processing module is further configured to receive a card change declaration, and if the card change declaration is received, the second processing module is stops executing the charge processing and shifts to the standby mode.

4. The card processing apparatus according to claim 1, wherein
the second processing module includes a module for displaying a screen for waiting for input of a charge amount on a display section, and
the standby module includes a module for displaying a screen instructing reading of a card having the electronic money function on the display section.

5. The card processing apparatus according to claim 4, wherein
the module for displaying the screen includes icons for payment methods including at least one of a cash payment icon, a credit card icon, a debit card icon, and a points icon.

6. The card processing apparatus according to claim 1, wherein
the card processing apparatus is a POS terminal.

7. A method of processing card data, comprising:
storing a first identification code if the first identification code relating to member information is acquired based on the card data;
storing a second identification code if the second identification code relating to electronic money is acquired based on the card data;
processing the member information based on the stored first identification code;
executing a charge processing of the electronic money based on the second identification code if a charge request for the electronic money is received in a first state in which the second identification code is stored; and
standing by until data of a card having an electronic money function is read if the charge request for the electronic money is received in a second state in which the second identification code is not stored.

8. The method of processing card data according to claim 7, further comprising:
standing by executing the charge processing until a charge amount is input and executing the charge processing of the electronic money using the input charge amount.

9. The method of processing card data according to claim 8, further comprising:
receiving a card change declaration,
stopping executing the charge processing, and
shifting to the standby mode.

10. The method of processing card data according to claim 7, further comprising:
displaying a screen for waiting for input of a charge amount, and
displaying a screen instructing reading of a card having the electronic money function.

11. The method of processing card data according to claim 10, wherein
displaying the screen includes displaying icons for payment methods including at least one of a cash payment icon, a credit card icon, a debit card icon, and a points icon.

12. A POS terminal, comprising:
a card reader configured to read card data;
a first storage module configured to store a first identification code if the first identification code relating to member information is acquired based on the card data;
a second storage module configured to store a second identification code if the second identification code relating to electronic money is acquired based on the card data;
a first processing module configured to process the member information based on the first identification code stored by the first storage module;
a second processing module configured to execute a charge processing of the electronic money based on the second identification code if a charge request for electronic money is received in a first state in which the second identification code is stored in the second storage module;
a standby module configured to stand by until data of a card having an electronic money function is read if the charge request for electronic money is received in a second state in which the second identification code is not stored in the second storage module; and
a receipt module for generating a receipt.

13. The POS terminal according to claim 12, wherein
the second processing module is in a stand by mode until a charge amount is input and executes the charge processing of the electronic money using the input charge amount.

14. The POS terminal according to claim 13, wherein
the second processing module is further configured to receive a card change declaration, and if the card change declaration is received, the second processing module is stops executing the charge processing and shifts to the standby mode.

15. The POS terminal according to claim 12, wherein
the second processing module includes a module for displaying a screen for waiting for input of a charge amount on a display section, and
the standby module includes a module for displaying a screen instructing reading of a card having the electronic money function on the display section.

16. The POS terminal according to claim 15, wherein
the module for displaying the screen includes icons for payment methods including at least one of a cash payment icon, a credit card icon, a debit card icon, and a points icon.

17. The POS terminal according to claim 12, wherein
the receipt module comprises a thermal printer.

18. The POS terminal according to claim 12, wherein
the receipt module comprises an inkjet printer.
